(19) United States
(12) Patent Application Publication
(10) Pub. No.: US 2026/0238471 A1
(43) Pub. Date: Aug. 13, 2026

(54) METHOD AND SYSTEM FOR ENHANCING SECURITY OF A SYSTEM

(71) Applicant: Marvell Asia Pte Ltd, Singapore (SG)

(72) Inventors: Phanikumar Kancharla, Folsom, CA (US); Minda Zhang, Westford, MA (US); Steven Barner, Shrewsbury, MA (US); Venkata Mohan Reddy Koppula, Fremont, CA (US); Anirudh Madnurkar, Fremont, CA (US)

(21) Appl. No.: 19/048,689

(22) Filed: Feb. 7, 2025

(51) Int. Cl. H04L 9/08; G06F 21/44; G06F 21/62

(52) U.S. Cl. CPC H04L 9/0877; G06F 21/445; G06F 21/6218

(57) ABSTRACT

A system includes a key provisioning and management unit configured to manage one or more cryptographical keys associated with one or more cryptographical operations. The system includes a hardware component for running an application supported by the hardware component. The key provisioning and management unit is configured to generate a cryptographic key within an internal environment of the key provisioning and management unit. The generated cryptographic key is transmitted from the key provisioning and management unit to the hardware component without exposing the generated cryptographic key in plaintext format to the application.

### BACKGROUND

Data security has become an integral part of daily life. Cyber attackers often exploit vulnerability in software to gain access to data. For example, hackers often exploit software vulnerabilities to gain access to data within a server platform, e.g., data random access memory (DRAM), storage units, medium access control (MAC), peripheral component interconnect (PCI), PCI express (PCIe), etc.

In order to protect data, software components or specialized management software may generate and rely on keys (e.g., cryptographic keys) to encrypt the data. For example, certificates and cryptographic keys are generally dynamically issued by specialized management applications such as secrets managers. However, the encryption keys are generally in plain format and exposed to software, e.g., hypervisor, kernel, application, etc. As such, if vulnerabilities of software are exploited, the key may be accessed and used to gain access to protected data (e.g., encrypted data). Vulnerabilities of software have been exploited to gain access to data, e.g., persistent cyber-attacks using side channel attacks, artificial intelligence (AI) based phishing attacks, security misconfiguration, software as a service (SaaS) broadening the attack surface with neighbor virtual machine (VM), complex runtime environments such as virtualized and cloud services allowing multiple applications from different vendors to run on the same system, complex runtime environment such as distributed and multivendor compute workflow (data processing being handled by different software applications), etc.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system with enhanced security according to one aspect of the present embodiments.

FIG. 2 depicts an example of communication between two components within a system according to one aspect of the present embodiments.

FIG. 3 depicts another example of communication between two components within a system according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Cryptographic keys play an important role in protecting sensitive data. Safeguarding the cryptographic keys has also become increasingly important in data security. Ideally, no application including the authorized ones, can have access to cryptographic keys as plain keys. Conventionally cryptographic keys are generated by software and managed by software, which as a result makes the cryptographic keys vulnerable if the cryptographic keys are in plaintext format. For example, in dynamic random access memory (DRAM) encryption, a key is generated during bootup of the system or the virtual machine, protecting data and application keys from cold boot or row hammer attacks. DRAM encryption protects a VM memory from other VMs outside the trusted boundary. However, vulnerabilities within the trusted boundary such as application, hypervisor, or basic input/output system (BIOS) may be exploited to gain access to plaintext cryptographic keys. In other words, DRAM encryption keys are provisioned by a trusted system software and as such the keys that are accessible to the application and system software are at risk when they are in plaintext format. As yet another example, PCIe integrity and data encryption (IDE) protects data on PCIe bus from physical snooping or tapping it leaves application-level system software vulnerabilities unresolved. In another example, confidential compute ensures that data used in a VM or enclave is isolated and protected from other entities on the compute note, by encrypting DRAM, while the VM and its application have access to the data and memory in plaintext format. However, confidential compute remains vulnerable due to vulnerabilities of application. As yet another example, self-encrypting drives (SED) secure data at rest by encrypting it using a data encryption key (DEK) generated on the device. The DEK remains locked until a user/system is authenticated using an authentication key (AK) that is managed by KSM and distributed to compute system firmware or special storage management application on the system through a secure channel and securely programs the SED. If vulnerabilities of software handling the AK is exploited then the AK can be exposed and unlock the SED DEK. As yet another example, MAC security (MACSec) may be used for network security where two key hierarchy, connectivity association key (CAK) and secure association key (SAK) are used. The CAK is programmed to the hardware and the SAK is derived using the CAK by the MACSec hardware for data protection. The CAK may be a pre-shared key or a dynamic key provisioned by a central server, e.g., remote authentication dial-in user service (RADIUS). However, software such as network driver or special management application are used to program the CAK to the MAC controller. As such, vulnerabilities of software may be exploited to gain access to the CAK and SAK. As yet another example, a special purpose device allowing applications to store keys encrypted in a keylocker with integrated hardware cryptographic engine supporting the operations using the encrypted keys. However, the keylocker requires application keys to be encrypted on the node, which exposes them for a period of time in plaintext, making them vulnerable. Additionally, key encryption key (KEK) used to protect keys in DRAM is not known to any external parties, therefore making it challenging to create an encrypted key store on a different compute node for high availability and load balancing. In summary, conventionally encryption mechanisms left cryptographic keys in plaintext accessible to software, thereby posing a significant risk of being exploited.

The security issue may be additionally compounded because in modern infrastructure, servers may physically host one organization with several applications or virtual appliances from other organizations, requiring additional trust among the parties. Accordingly, a need has arisen to ensure that cryptographic keys in plaintext format are not accessible to software components because hackers often exploit vulnerabilities of software to circumvent security and to gain access to plaintext cryptographic keys.

A hardware component for cryptographic key provisioning and management may be used to protect cryptographic keys and to prevent software components, external to the hardware component, from accessing cryptographic keys in plaintext format. In other words, hardware-level key encryption/decryption and management is used to provide a robust security defense for data (during storage, during transmission, during processing). One nonlimiting example of a hardware component for cryptographic key provisioning and management may be a hardware security module (HSM). HSM is a physical computing device that safeguards and manages secret and confidential information (e.g., digital keys and data) of a user. HSM typically has certain security protection measures in place to prevent tampering by cyberattacks and plays a vital role in providing a security environment for various cryptographic operations such as encryption and decryption, digital signatures, strong authentication, as well as other cryptographic functions. HSMs are mainly used to generate, derive, store, and manage cryptographic keys, secure computation via encryption and decryption, and protect sensitive data of the user from unauthorized access and attacks.

In some embodiments, cryptographic keys may be generated by HSM (or software operating within the HSM environment (internal environment)) and stored within a hardware component in HSM. When the cryptographic key is needed, it may be transmitted from HSM to the requesting hardware component via a secure channel, e.g., physical channel such as point-to-point, logical channel, etc. According to some embodiments, the cryptographic key may be generated by the HSM and transmitted without being stored within the HSM. It is appreciated that the cryptographic key being transmitted may be in plaintext format or may be encrypted prior to being sent. According to some embodiments, the HSM that provisions and manages cryptographic keys enhances the security of the system by providing a hardware root of trust for secure Boot of the hardware platform and by managing cryptographic keys securely to ensure compliance with industry security standards. HSM may be within a cryptographic unit that manages keys and provides services associated with the cryptographic keys. In some embodiments, applications (external software components) being executed on a processing core may offload their cryptographic operations to cryptographic unit. HSM may in general handle service requests associated with key management, encryption/decryption, digital signature and verification, authentication, auditing, secure code execution, sign and verify, key generation, hashing operation, key wrapping, pin translation, Europay Mastercard Visa (EMV) operation, card verification value (CVV) generation and verification, derive unique key per transaction (DUKPT), etc. The cryptographic accelerator may perform computationally intensive portion of the cryptographical operation.

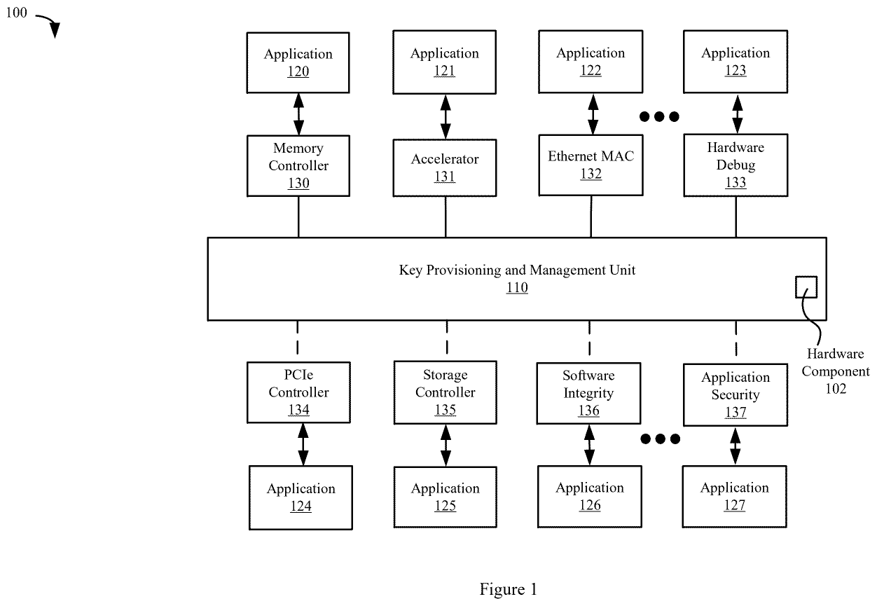

FIG. 1 depicts an example of a system 100 with enhanced security according to one aspect of the present embodiments. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

The system 100 may be a system on a chip (SoC) and may include a hardware component such as a key provisioning and management unit 110, e.g., a HSM configured to perform cryptographic key provisioning and management (e.g., key generation, key export, key deletion, secured key and data storage). Cryptographic keys may include but are not limited to advanced encryption standard (AES), a Rivest-Shamir-Adleman (RSA), an Elliptic Curve Cryptography (ECC), etc. HSM may be a physical computing device that safeguards and manages secret and confidential information (e.g., digital keys and data) of a user. HSM has security protection measures in place to prevent tampering by cyberattacks and plays a vital role in providing a security environment for various cryptographic operations such as encryption and decryption, digital signatures, strong authentication, as well as other cryptographic functions. HSM may be used to generate, derive, store, and manage cryptographic keys, secure computation via encryption and decryption, and protect sensitive data of the user from unauthorized access and attacks. In some embodiments, the HSM is certified under Federal Information Processing Standard (FIPS) Level 2 and 3 for performing secured key management cryptographic (crypto) operations. In some embodiments, the HSM is preconfigured with default network and authentication credentials so that the HSM can be FIPS/Common Criteria/PCI compliant for key management and crypto operations. In some embodiments, the FIPS certified HSM includes one or more processors and storage units (not shown). It is appreciated that the HSM may be configured to prevent access of external components, e.g., applications running on processing cores, external memory components, etc., to the HSM. In other words, HSM may be configured to behave as a receiving mailbox where it receives requests for service without providing access to the requesting entity. In one nonlimiting example, HSM incorporates isolated, access controlled on-chip memory for storing keys (e.g., cryptographic keys) and policies, to prevent unauthorized software components from accessing the keys and ensuring their protection. In one nonlimiting example, HSM may include a detection logic for detecting certain tamper events and for receiving notification from other trusted components within the system to enable a comprehensive tamper response mechanism.

The key provisioning and management unit 110 may be used to protect cryptographic keys and to prevent software components, external to the key provisioning and management unit 110, from accessing cryptographic keys in plaintext format. In one nonlimiting example, a cryptographic key may be generated within the key provisioning and management unit 110 and stored within a hardware component 102, e.g., internal memory component, of the key provisioning and management unit 110. It is appreciated that in one nonlimiting example, the cryptographic key may be transmitted to a hardware component, e.g., memory controller 130, accelerator 131, Ethernet MAC 132, hardware debug 133 component, PCIe controller 134, storage controller 135, software integrity 136, application security 137, etc., as described below, without being stored within the key provisioning and management unit 110. In one nonlimiting example, the cryptographic key generated within the key provisioning and management unit 110 is generated by a hardware component within the key provisioning and management unit 110. As yet another nonlimiting example, the cryptographic key generated within the key provisioning and management unit 110 is generated by a software component within the key provisioning and management unit 110. In other words, the cryptographic key being generated is not exposed to an environment external to the key provisioning and management unit 110. The key provisioning and management unit 110 may include an interface for connecting the key provisioning and management unit 110 to other components, e.g., through a secure physical/logical channel (described in more detail below).

The system 100 may also include a number of hardware components and their respective software components that are coupled to the key provisioning and management unit 110. For example, the system 100 may include a memory controller 130 coupled to its application 120 (e.g., double data rate (DDR)), an accelerator 131 and its application 121 (e.g., cryptography accelerator, machine learning hardware, inference engine, etc.), an Ethernet MAC 132 and its application 122 (e.g., network interface controller (NIC)), a hardware debug 133 component and its application 123, a PCIe controller 134 and its application 124, a storage controller 135 and its application 125 (e.g., serial advanced technology attachment (SATA)), a software integrity 136 component and its application 126, and an application security 137 and its application 127. The key provisioning and management unit 110 is configured to prevent software components external to the key provisioning and management unit 110, e.g., applications 120-127, from having access to plaintext format of cryptographic keys of the key provisioning and management unit 110. It is appreciated that the components shown are for illustrative purposes and the embodiments should not be construed as limited thereto. For example, in one nonlimiting example, additional components or fewer components may be present.

According to one nonlimiting example, each application may be associated with its own host software and application programming interface (API). It is appreciated that each application, e.g., application 120-127, may generate a request for performing a cryptographical operation. Cryptographic operation/service may include but are not limited to advanced encryption standard (AES) operation, data encryption standard (DES) operation, encryption/decryption, digital signature and verification, authentication (to ensure that only authorized users and systems can access certain data (e.g., sensitive data and/or service such as bias/weights associated with an AI/ML model)), auditing (for forensic analysis and compliance), secure code execution (to execute custom code in secure boundaries), secure code execution, sign and verify, key generation, hashing operation, key wrapping, pin translation, Europay Mastercard Visa (EMV) operation, card verification value (CVV) generation and verification, derive unique key per transaction (DUKPT), symmetric hash, symmetric cryptography, asymmetric operations associated with public key algorithm, and provisioning of Internet Protocol Security (IPsec), etc.

In one nonlimiting example, the memory controller 130, the accelerator 131, the Ethernet MAC 132, and the hardware debug 133 component are coupled to the key provisioning and management unit 110 using a secure physical channel. The secure physical channel does not involve software for identifying the components involved in a communication. For example, unlike the conventional system that uses a configuration bus and involves software to identify the parties to a communication and to perform certain authentication/verification steps, involvement of software in the embodiments is eliminated and communication occurs through the secure physical channel. As an illustrative example, the key provisioning and management unit 110 may identify the Ethernet MAC 132 as the Ethernet MAC component to communicate with. The key provisioning and management unit 110 may perform proper identification and authentication of the Ethernet MAC 132, and may deliver appropriate cryptographic keys to the Ethernet MAC 132 using the secure physical channel between the two components after proper identification and authentication of the Ethernet MAC 132. In one nonlimiting example, the identification of the component may be via device identifier composition engine (DICE).

In one nonlimiting example, the PCIe controller 134, the storage controller 135, the software integrity 136, and the application security 137 are coupled to the key provisioning and management unit 110 using a secure logical channel. Secure logical channel refers to indirect connections related to security (e.g., may reside outside of the chip) and may utilize protocols such as transport layer security (TLS) or other protocols for security verification/identification/authentication. According to one nonlimiting example, a secure logical channel may be established between two components by mutual authentication of a channel to transfer locally generated or received cryptographic keys. It is appreciated that identification, authentication, verification, etc., may be performed by the key provisioning and management unit 110 and involvement of software, e.g., configuration software, is eliminated, thereby improving the security of the system 100. In one nonlimiting example, the device identification may be via DICE and security protocol and data model (SPDM) for implementing logical secure channel to deliver keys to those identified hardware components.

According to some embodiments, in a secure physical/logical channel, hardware identification, root of trust (RoT), chain of trust (CoF), etc., may be used to mutually authenticate the components and to eliminate the need to use configuration bus.

According to some embodiments, one or more applications, e.g., application 121 running on the accelerator 131, may perform/request a cryptographic operation. It is appreciated that the cryptographic keys may be generated by the key provisioning and management unit 110 and within its environment without exposing the plaintext cryptographic key to external software, e.g., application 121, even though the application 121 may be a trusted application. Any communication between the key provisioning and management unit 110 and the accelerator 131 is through the secure physical channel without involvement of configuration software, thereby improving the security of the system. In one nonlimiting example, the cryptographic keys being exchanged between the key provisioning and management unit 110 and the accelerator 131 is in encrypted form while in other examples it may be in plaintext form. It is appreciated that since a secure direct channel is used between the key provisioning and management unit 110 and the accelerator 131, the cryptographic keys may be exchanged in plaintext form without the cryptographic keys being exposed to software components external to the key provisioning and management unit 110.

The key provisioning and management unit 110 may be partitioned for multi-tenant use in hyperscale datacenter environments. In other words, virtual machines and virtual environments may be implemented by the key provisioning and management unit 110. Accordingly, during cryptography setup, the key provisioning and management unit 110 validates the identity of the hardware components, e.g., memory controller 130, accelerator 131, Ethernet MAC 132, hardware debug 133, PCIe controller 134, etc. If the identity of the hardware component, e.g., Ethernet MAC 132, is verified, then key establish protocol (key establishment process) is initiated, e.g., symmetric cryptographic, asymmetric cryptography, connection key, session key, public/private key, etc.

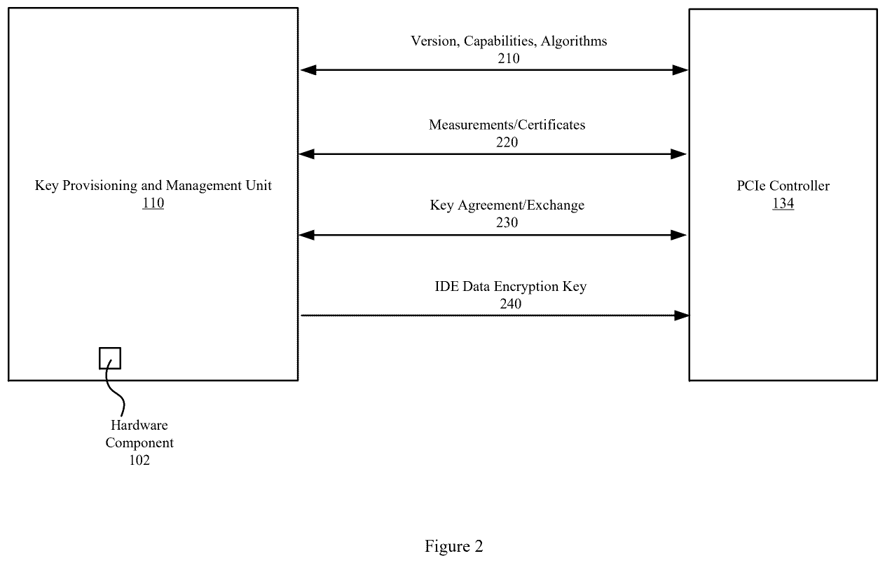

FIG. 2 depicts an example of communication between two components within a system according to one aspect of the present embodiments. In this nonlimiting example, the key provisioning and management unit 110 is in secure logical channel (e.g., SPDM) with the PCIe controller 134. In this nonlimiting example, plaintext format of the cryptographic key generated (e.g., by software or hardware) within the key provisioning and management unit 110 is prevented from being exposed to external software components, e.g., application 124. In this nonlimiting example, plaintext cryptographic key or encrypted cryptographic key may be stored in the hardware component 102. The key provisioning and management unit 110 may identify the identity of the PCIe controller 134 and may authenticate the PCIe controller 134 without involvement of configuration bus or other software components external to the key provisioning and management unit 110 environment. In this nonlimiting example, version, capabilities, and algorithms 210 associated with the PCIe controller 134 is identified/verified without involvement of configuration bus or other software components external to the key provisioning and management unit 110 environment. Additionally, in this nonlimiting example, measurements/certificates 210 associated with the PCIe controller 134 is identified/verified without involvement of configuration bus or other software components external to the key provisioning and management unit 110 environment. Accordingly, the key provisioning and management unit 110 and the PCIe controller 134 may enter into key agreement/exchange 230 without involvement of configuration bus or other software components external to the key provisioning and management unit 110 environment. As such, the key provisioning and management unit 110 may subsequently transmit IDE data encryption key 240 to the PCIe controller 134 without involvement of the software component associated with the PCIe controller 134, e.g., application 124.

As illustrated, since the software component external to the key provisioning and management unit 110 is not involved in the cryptographic operation/request, the cryptographic key generated by the key provisioning and management unit 110 remains secure and inaccessible in plaintext format by the application 124. Additionally, since a secure logical channel is used instead of a configuration bus, security of the channel between the key provisioning and management unit 110 and the PCIe controller 134 is enhanced by removing involvement of software (external to key provisioning and management unit 110) in communication between the two components.

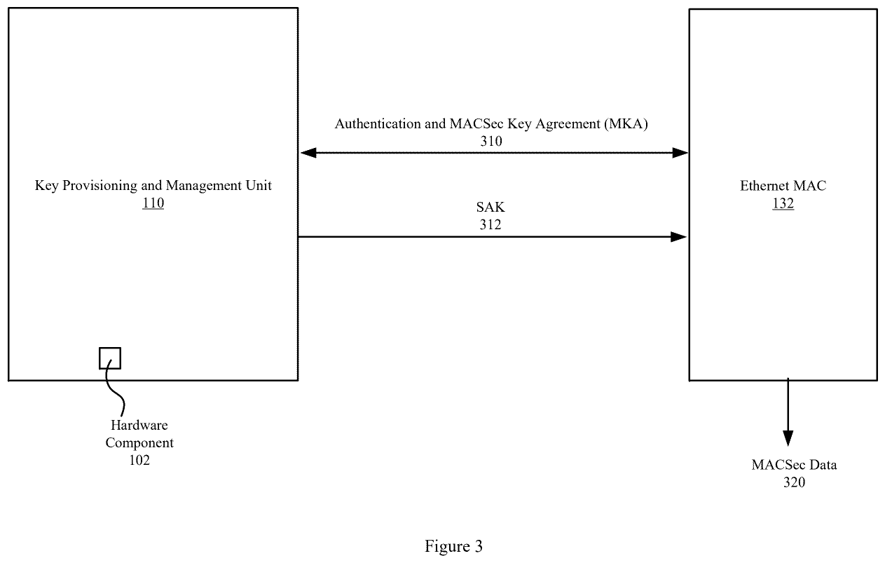

FIG. 3 depicts another example of communication between two components within a system according to one aspect of the present embodiments. In this nonlimiting example, the key provisioning and management unit 110 is in secure physical channel with the Ethernet MAC 132. In this nonlimiting example, plaintext format of the cryptographic key generated (e.g., by software or hardware) within the key provisioning and management unit 110 is prevented from being exposed to external software components, e.g., application 122. In this nonlimiting example, plaintext cryptographic key or encrypted cryptographic key may be stored in the hardware component 102. For example, the key provisioning and management unit 110 may be involved in pre-shared key (PSK) or certificate authentication with the Ethernet MAC 132. It is appreciated that the key provisioning and management unit 110 may identify the identity of the Ethernet MAC 132 and may authenticate the Ethernet MAC 132 without involvement of configuration bus or other external software components, e.g., application 122, to the key provisioning and management unit 110 environment and exchange MACSec key agreement (MKA) with the Ethernet MAC 132. In other words, the key provisioning and management unit 110 verifies the identity of the Ethernet MAC 132 and/or firmware integrity before running MKA to create the CKA. Authentication and MKA 310 may be exchanged with the Ethernet MAC 132 via the secure physical channel between the two components as opposed to using a configuration bus of the conventional system.

In one nonlimiting example, the key provisioning and management unit 110 may derive the CAK key based on the MKA between the two components. The CAK key may be secured using SAK key and may be stored in the hardware component 102. It is appreciated that the SAK key 312 may be sent to the Ethernet MAC 132. In one nonlimiting example, the SAK key 312 is transmitted over a secure channel. It is appreciated that MACSec data 320 may be communicated between the Ethernet MAC 312 and peer Ethernet MAC once the SAK key is received by the Ethernet MAC 132.

As illustrated, since the software component external to the key provisioning and management unit 110 is not involved in the cryptographic operation/request, the cryptographic key generated by the key provisioning and management unit 110 remains secure and inaccessible in plaintext format by the application 122. Additionally, since a secure physical channel is used instead of a configuration bus, security of the channel between the key provisioning and management unit 110 and the Ethernet MAC 132 is enhanced by removing involvement of software (external to key provisioning and management unit 110) in communication between the two components.

It is appreciated that the examples of FIGS. 2-3 with respect to two hardware components and their respective applications are provided for illustration purposes and should not be construed as limiting the scope of the embodiments. As one nonlimiting example, the accelerator 131 may be a cryptographical accelerator configured to receive cryptographic offload requests. The accelerator 131 may receive one or more encrypted cryptographic keys wrapped with a key encryption key (KEK) from the key provisioning and management unit 110, as described above, in a secure fashion that makes the key inaccessible by external software components. The key provisioning and management unit 110 programs the KEK into the accelerator 131. The application 121 uses the encrypted key in the requests submitted to the accelerator 131 without having access to the plaintext format of the cryptographic key itself. The KEK is known only to the key provisioning and management unit 110 and the accelerator 131 and not by the application 121, thereby enhancing the security.

Accordingly, other applications, e.g., 120-121, 123, and 125-127 that are external to the key provisioning and management unit 110 are prevented from having access to plaintext format of cryptographic keys being generated by the key provisioning and management unit 110. Additionally, since the hardware components, e.g., memory controller 130, accelerator 131, hardware debug 133, storage controller 135, software integrity 136, and application security 137, are connected to the key provisioning and management unit 110 using a secure logical/physical channel, involvement of configuration bus and other software components are eliminated, thereby further enhancing the security of the system.

As presented above, the key provisioning and management unit 110 such as HSM provides a centralized key management to other hardware components while preventing external software components from having access to plaintext format of cryptographic keys generated by the key provisioning and management unit 110. Since software components and their vulnerabilities have been exploited to access data, eliminating software components external to the key provisioning and management unit 110 result in enhanced security. Moreover, the security is further enhanced by utilizing secure logical/physical channel between the key provisioning and management unit 110 and other hardware components while eliminating use of configuration bus for communication between the two components.

As illustrated, the key provisioning and management unit 110 may be used as a central key manager, e.g., DEKs, and to distribute the keys to hardware components over secure physical/logical channels, while preventing software components from having access to the keys. In one nonlimiting example, hardware identifier, RoT, CoT, etc., may be used for mutual authentication of components. Moreover, as described above, the plaintext cryptographic key may be encrypted before being sent by the key provisioning and management unit 110 to another hardware component, thereby preventing the application associated with the hardware component from having access to the plaintext format of cryptographic key. In other words, software components external to the key provisioning and management unit 110 may use encrypted cryptographic keys without having access to the plaintext form of the cryptographic key, thereby reducing the risk of being compromised.

It is appreciated that as described above, the key provisioning and management unit 110 may be used in a multi-tenant environment and the DEK may be used setup for each virtual entity. The key provisioning and management unit 110 may implement tenant aware protocols to create/bind respective keys to each tenant in its memory and further to distribute those keys to the multi-tenant aware hardware components. It is further appreciated that the key provisioning and management unit 110 may validate the integrity of the system software and hardware before distributing keys to ensure that trusted and verified components receive the keys.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system comprising:
a hardware component for running an application supported by the hardware component; and
a key provisioning and management unit configured to
manage one or more cryptographical keys associated with one or more cryptographical operations by the hardware component;
generate a cryptographic key within an internal environment of the key provisioning and management unit; and
transmit the generated cryptographic key to the hardware component without exposing the generated cryptographic key in plaintext format to the application.

2. The system of claim 1, wherein the key provisioning and management unit is a hardware security module (HSM).

3. The system of claim 1, wherein the cryptographic key is generated by another hardware component within the key provisioning and management unit.

4. The system of claim 1, wherein the cryptographic key is generated by a software component within the internal environment of the key provisioning and management unit.

5. The system of claim 1, wherein the generated cryptographic key is encrypted by the key provisioning and management unit before being sent to the hardware component.

6. The system of claim 1, wherein the key provisioning and management unit is coupled to the hardware component through a secure physical channel.

7. The system of claim 6, wherein the key provisioning and management unit is configured to identify and authenticate the hardware component using a device identifier composition engine (DICE).

8. The system of claim 1, wherein the key provisioning and management unit is coupled to the hardware component through a secure logical channel.

9. The system of claim 8, wherein the logical channel is formed by performing mutual authentication by the key provisioning and management unit and the hardware component.

10. The system of claim 1, wherein the hardware component is an Ethernet medium access control (MAC), and wherein the key provisioning and management unit is configured to generate and store a secure association key (SAK) and transmit the SAK as a MAC security (MACSec) to the Ethernet Mac.

11. The system of claim 1, wherein communication of the generated cryptographic key between the key provisioning and management unit and the hardware component is without utilizing a configuration bus.

12. The system of claim 1, wherein the hardware component is one of a memory controller, an accelerator, an Ethernet medium access (MAC), hardware debug, peripheral component interconnect (PCI), PCI express (PCIe), storage controller, software integrity, or application security.

13. The system of claim 1, wherein the key provisioning and management unit managing one or more cryptographic keys includes one or more of key generation, key export, key deletion, and secured key storage.

14. The system of claim 1, wherein the key provisioning and management unit is further configured to store the generated cryptographic key within an internal hardware component within the key provisioning and management unit.

15. A system comprising:
a plurality of hardware components and a plurality of software components running on the plurality of hardware components, wherein each software component of the plurality of software components is associated with a respective hardware component of the plurality of hardware components; and
a hardware security module (HSM) configured to manage one or more cryptographical keys associated with one or more cryptographical operations by the plurality of hardware components ;
generate a cryptographic key within an internal environment of the HSM; and
transmit the generated cryptographic key to one hardware component of the plurality of hardware components without exposing the generated cryptographic key in plaintext format to the plurality of software components.

16. The system of claim 15, wherein the generated cryptographic key is not exposed to hardware components of the plurality of hardware components other than the one hardware component.

17. The system of claim 15, wherein the cryptographic key is generated by a software component within an internal environment of the HSM.

18. The system of claim 15, wherein the cryptographic key is generated by another hardware component within an internal environment of the HSM.

19. The system of claim 15, wherein the generated cryptographic key is encrypted by the HSM before being sent to the one hardware component.

20. The system of claim 15, wherein the HSM is coupled to the one hardware component through a secure physical channel.

21. The system of claim 20, wherein the HSM is configured to identify and authenticate the one hardware component using a device identifier composition engine (DICE).

22. The system of claim 15, wherein the HSM is coupled to the one hardware component through a secure logical channel.

23. The system of claim 22, wherein the logical channel is formed by performing mutual authentication by the HSM and the one hardware component.

24. The system of claim 15, wherein the one hardware component is an Ethernet medium access control (MAC), and wherein the HSM is configured to generate and store a secure association key (SAK) and transmit the SAK as a MAC security (MACSec) to the Ethernet Mac.

25. The system of claim 15, wherein communication of the generated cryptographic key between the HSM and the one hardware component is without utilizing a configuration bus.

26. The system of claim 15, wherein the one hardware component is one of a memory controller, an accelerator, an Ethernet medium access (MAC), hardware debug, peripheral component interconnect (PCI), PCI express (PCIe), storage controller, software integrity, or application security.

27. The system of claim 15, wherein the HSM managing one or more cryptographic keys includes one or more of key generation, key export, key deletion, and secured key storage.

28. The system of claim 15, wherein the HSM is further configured to store the generated cryptographic key within the HSM without exposing the generated cryptographic key to an environment outside of the HSM.

29. A hardware security module (HMS) comprising:
an internal memory component configured to store data internal to the HSM and prevent external components to the HSM from accessing the stored data; and
an interface configured to couple the HSM to a hardware component for running an application supported by the hardware component,
wherein the HSM is configured to:
manage one or more cryptographical keys associated with one or more cryptographical operations by the hardware component,
generate a cryptographic key within an internal environment of the HSM, and
transmit the generated cryptographic key to the hardware component without exposing the generated cryptographic key in plaintext format to the application.

30. The HSM of claim 29, wherein the cryptographic key is generated by another hardware component within the HSM.

31. The HSM of claim 29, wherein the cryptographic key is generated by a software component within the internal environment of the HSM.

32. The HSM of claim 29, wherein the generated cryptographic key is encrypted by the HSM before transmitting the generated cryptographic key to the hardware component.

33. The HSM of claim 29, wherein the interface couples the HSM to the hardware component through a secure physical channel.

34. The HSM of claim 33, wherein the HSM is configured to identify and authenticate the hardware component using a device identifier composition engine (DICE).

35. The HSM of claim 29, wherein the interface couple is coupled to the hardware component through a secure logical channel.

36. The HSM of claim 35, wherein the logical channel is formed by performing mutual authentication by the HSM and the hardware component.

37. The HSM of claim 29, wherein the hardware component is an Ethernet medium access control (MAC), and wherein the HSM is configured to generate and store a secure association key (SAK) and transmit the SAK as a MAC security (MACSec) to the Ethernet Mac.

38. The HSM of claim 29, wherein communication of the generated cryptographic key between the HSM and the hardware component is without utilizing a configuration bus.

39. The HSM of claim 29, wherein the hardware component is one of a memory controller, an accelerator, an Ethernet medium access (MAC), hardware debug, peripheral component interconnect (PCI), PCI express (PCIe), storage controller, software integrity, or application security.

40. The HSM of claim 29, wherein the HSM managing one or more cryptographic keys includes one or more of key generation, key export, key deletion, and secured key storage.

41. The HSM of claim 29, wherein the HSM is further configured to store the generated cryptographic key within the internal memory component.

42. A method comprising:
managing one or more cryptographical keys associated with one or more cryptographical operations by a hardware component;
generating a cryptographic key within an internal environment; and
transmitting the generated cryptographic key to the hardware component without exposing the generated cryptographic key in plaintext format to an application running on the hardware component.

43. A system comprising:
a means for managing one or more cryptographical keys associated with one or more cryptographical operations by a hardware component;
a means for generating a cryptographic key within an internal environment; and
a means for transmitting the generated cryptographic key to the hardware component without exposing the generated cryptographic key in plaintext format to an application running on the hardware component.
